(19) United States
(12) Patent Application Publication
(10) Pub. No.: US 2022/0324058 A1
(43) Pub. Date: Oct. 13, 2022

(54) MICROPERFORATION METHOD WITH A MOVING WEB

(71) Applicant: INTERLAS GmbH & Co. KG, Ummendorf (DE)

(72) Inventors: Bernhard LANG, Ummendorf (DE); Christian LANG, Ummendorf (DE)

(73) Assignee: INTERLAS GmbH & Co. KG, Ummendorf (DE)

(21) Appl. No.: 17/443,854

(22) Filed: Jul. 28, 2021

(30) Foreign Application Priority Data
Apr. 9, 2021 (EP) 21 167 745.5

(51) Int. Cl. B23K 26/382; B23K 26/08; B23K 26/067; B23K 26/06; B23K 26/402

(52) U.S. Cl. CPC B23K 26/382; B23K 26/083; B23K 26/0676; B23K 26/0643; B23K 26/402; B23K 2103/40

(57) ABSTRACT

A method is proposed for producing a packaging, having a method step of microperforation of a flexible material as a packaging film, comprising: provision of the flexible material as a packaging film, transport of the flexible material over a transport section, provision of a laser in order to generate a perforation of the flexible material with its beam. For a packaging with improved gas exchange, a laser system with a wavelength in the range of from 150 nm to 1064 nm, preferably from 355 nm to 532 nm, is used for the laser, and the perforation with the laser is carried out during the movement of the flexible material of the packaging film during the transport.

This application claims the benefit under 35 USC § 119(a)-(d) of European Application No. 21 167 745.5 filed Apr. 9, 2021, the entirety of which is incorporated herein by reference.

### FIELD OF THE INVENTION

The present invention relates to a method for producing a packaging by microperforation of a flexible material, preferably a packaging film, and a corresponding apparatus.

### BACKGROUND OF THE INVENTION

From the prior art, in the field of M.A.P. (Modified-Atmosphere Packaging), packagings are known which have a modified atmosphere in order, for example, to increase the shelf life of a packaged product. For gas exchange through the packaging film, there are already perforation solutions using a laser beam.

### SUMMARY OF THE INVENTION

It is an object of the present invention to propose a method for producing a packaging, which method can offer improved tailoring of the gas exchange, especially for sensitive products.

The method according to the present invention for producing a packaging provides microperforation of a flexible material, preferably a packaging film, and is suitable particularly for the production of packagings of particularly sensitive products, especially in the pharmaceutical and medical fields, but also foodstuffs, especially when they are intended to be stored in a special gas.

Firstly, a flexible material, which may in particular be employed as a packaging film, is in this case used and conveyed over a transport section. A laser having a laser system is used for the perforation, the laser beam generating the perforation holes in the flexible material.

For example, conveyance of the flexible material, which is in the form of a web, from roll to roll is used for the transport. The web may thus advantageously be tensioned for the processing. Between the rolls, the web is then also not in contact with a base which may impede the processing of the workpiece.

The perforation essentially allows gas exchange. Foodstuffs which ferment or degas after packaging, for example fresh dough, roasted coffee beans, sauerkraut or milk products, require very small holes in order to release the gases, for example CO₂ gas, formed during the fermenting or maturing. A packaging closed in a gas-tight fashion could otherwise expand and possibly even tear.

Furthermore, a packaging closed in a gas-tight fashion could otherwise expand very greatly even during warming. Sometimes, especially in the case of packaged foodstuffs, it is occasionally even desired for air or oxygen to enter so that the products can breathe and do not perish or even ripen further, so long as the gas exchange can be kept within a certain extent.

Accordingly, the method according to the present invention is distinguished in that the laser in a wavelength range of from 150 nm to 1064 nm, particularly preferably from 355 nm to 532 nm, is used. According to the present invention, it is recognized that a shorter wavelength also has effects on the hole diameter during the perforation. In general, UV light (typically with wavelengths from 150 nm) is used in order to generate holes that are as small as possible. The following laser systems may inter alia be considered as exemplary embodiments:

an excimer laser; and/or

a UV laser; and/or

a nanosecond laser; and/or

a Q-switched DPSS solid-state laser (DPSS: diode-pumped solid state laser).

The particularly small perforation holes are made according to the present invention during the movement of the flexible material, or of the packaging film, during the transport. By the reduced hole diameter, the gas exchange can be tailored even better for the requirements of sensitive products. By the smaller diameter, the gas exchange is initially reduced superproportionally for a perforation hole. In order to increase the gas exchange, for example, the number of perforation holes in the packaging may therefore be increased. The adaptation of the gas exchange may, however, be selected and tailored more accurately because of the perforation holes reduced in size, since a finer grid is available for selecting the total area of the perforation holes, according to which the gas exchange is determined.

The production of the packaging is improved in that the perforation may take place during the transport into the moving web of flexible material, or into the packaging film, which also entails a significant time advantage by reduced production times.

In one particularly preferred embodiment of the present invention, the workpiece, that is to say the web, moves while the laser is stationary and is not moved. The laser beam is then initially, at least without further downstream optics, directed onto a fixed point. Correspondingly the laser may be arranged at a particular point of the transport section and directed onto this fixed point. It is then turned on as soon the flexible material and/or the web is in the position through the transport apparatus at which one of the holes is intended to be produced. The transporting of the flexible material is carried out continuously. The holes are generated in the material with the laser during the movement. The time which is respectively required in order to produce the perforations is very short, and the speed of the material during the transport is too slow for the holes to be distorted thereby. Instead, the laser beam may however also be jointly guided with the movement of the flexible material.

In order, however, also to be able to introduce very rapid or more complex patterns of holes into the flexible material, in one embodiment it is possible to provide optics which are adjustable by means of one or more galvanometers in order to steer the laser beam onto the desired position, even if the laser itself is arranged stationary, that is to say is not moved, or the laser beam directly generated by it initially travels without these further optics on a set path section, or is directed onto a fixed point. This embodiment has the advantage that relatively light mirrors or mirror elements can be adjusted very rapidly. In general, the positioning may then also be carried out with a very high speed. The laser beam is focused on the flexible material by means of a simple lens, a far-field lens, or an optical system in which a mirror is deflected and the laser beam is moved synchronously with the material path via the lens to the focus plane during the pulse time.

It is, however, also conceivable in principle to position the laser as a whole.

The optics may, for example, comprise a mobile mirror and a focusing device. The laser beam may advantageously be jointly guided synchronously with the moved flexible material during one or more pulses (burst mode). In this way, particularly precise holes may be made.

In order, in the case of more rapid movements, to avoid high accelerations which may cause damage to the equipment and which are generally associated more with low speeds during the positioning of the laser beam, the laser and/or the laser beam may execute a predetermined, especially a smooth, path curve on which individual perforation holes are generated with a temporal and/or positional spacing.

In order to be able to save further time during production, the laser beam may be split, for example, by diffractive optics, into two or more beams in order to generate a corresponding number of perforation holes simultaneously in the material.

Depending on which flexible material is intended to be perforated and the way in which the perforation holes are intended to be configured, the laser may be operated in single-pulse operation or multiple-pulse operation (burst mode). Inter alia, the energy input into the material also depends thereon.

In one refinement of the present invention, perforation holes of from 1 μm to less than 15 μm, by which a particularly high adaptability of the gas exchange is possible, are generated. In particular, perforation holes with diameters of less than 50 μm, preferably with less than 25 μm, may be generated.

The holes may be configured and arranged in different ways. One arrangement which is advantageous for production consists of a repeating circular configuration, which promotes uniform coverage and consistent gas exchange.

In particular, the following flexible materials may be considered as a packaging material which is intended to be perforated:

at least two flexible materials as a composite; and/or

a monofilm and/or a two-layer or multilayer film composite;

a polymer film; and/or

a polymer film having an aluminum layer; and/or

an aluminum layer; and or

a paper web; and/or

a biologically degradable film.

It is conceivable to use a composite material. A biologically degradable film can be broken down biologically, that is to say by living organisms or enzymes thereof.

### BRIEF DESCRIPTION OF THE DRAWINGS

An exemplary embodiment of the present invention is represented in the drawing and will be explained in more detail below while specifying further details and advantages.

FIG. 1 shows a perforation apparatus for a production method of a packaging according to the present invention.

### DETAILED DESCRIPTION OF THE INVENTION

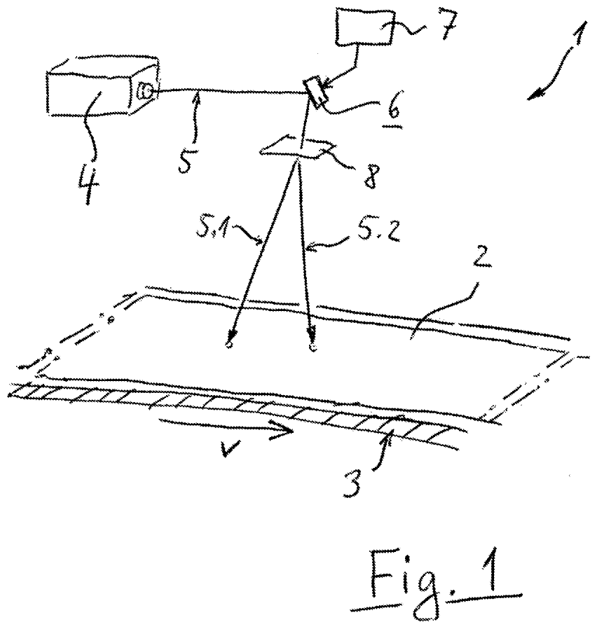

FIG. 1 shows an apparatus 1 for producing a packaging by perforation of the packaging film 2 from a flexible material. The film 2 is moved uniformly with a constant speed v (in FIG. 1 in the arrow direction toward the right) by a transport apparatus 30 for conveying the film web 2. The transport apparatus 3 uses conveyance of the film web 2 from roll to roll, that is to say rolls are arranged at certain distances and the film runs in the tensioned state from roll to roll. In the region between the rolls, simplified processing of the film web 2 may therefore also take place. A laser 4 (for example, a UV laser having a wavelength of 355 nm) generates laser pulses. The laser beam 5 is deflected by the adjustable mirror 6, the galvanometric positioning apparatus 7 adjusting the mirror 6 in order to set the desired position of the split light beams 5.1, 5.2 on the film 2 after passing through a diffractive element 8. The perforation holes are respectively generated where the partial beams 5.1, 5.2 impinge on the film 2. The laser beam 5, or the partial beams 5.1, 5.2, may be jointly moved synchronously with the movement of the film 2.

A common feature of all exemplary embodiments and refinements of the present invention is that in order to produce a packaging with improved gas exchange, a laser system having a wavelength in the range of from 150 nm to 1064 nm, preferably from 355 nm to 532 nm, is used, and the perforation with the laser is carried out during the movement of the flexible material of the packaging film during the transport, in particular by synchronous joint guiding of the laser beam, or partial beams thereof.

### LIST OF REFERENCES

1 apparatus for producing a packaging by perforation
2 packaging film
3 transport apparatus
4 laser
5 laser beam
5.1 partial beam
5.2 partial beam
6 mirror (adjustable)
7 galvanometric positioning apparatus
8 diffractive optics
v transport speed

1. A method for producing a packaging, having a method step of microperforation of a flexible material as a packaging film, comprising:
providing the flexible material as a packaging film,
transporting the flexible material over a transport section,
using a beam from a laser to generate a perforation of the flexible material,
wherein the laser beam is provided by a laser system with a wavelength in the range of from 150 nm to 1064 nm, wherein the laser system includes one of:
i. an excimer laser;
ii. a UV laser;
iii. a nanosecond laser; and
iv. a Q-switched DPSS solid-state laser, and
wherein the perforation with the laser is carried out during the movement of the flexible material of the packaging film during the transport.

2. The method according to claim 1, wherein, during the perforation, optics are used to position the laser beam and/or the laser beam is positioned by tilting and/or translation of the laser with respect to the perforation.

3. The method according to claim 1, wherein the laser beam and/or partial beams of the laser, which are split from the laser beam, is/are jointly guided synchronously, at least segmentally, with the movement of the flexible material, the laser beam of the laser being positioned and/or displaced by means of a mobile mirror and a focusing device.

4. The method according to claim 1, wherein the laser and/or the laser beam executes a path curve on which individual perforation holes are generated with a temporal and/or positional spacing, the laser beam being moved with a path speed of at least 30 m/min on the packaging film.

5. The method according to claim 1, wherein the laser is operated in single-pulse operation.

6. The method according to claim 1, wherein the laser is operated in a multiple-pulse method.

7. The method according to claim 1, wherein the laser generates perforation holes in the diameter range of between 1 μm and 50 μm.

8. The method according to claim 7, wherein the holes are generated as holes of a repeating circular configuration.

9. The method according to claim 1, wherein the flexible material as a packaging film comprises at least one of the following:
a further flexible material;
a monofilm and/or a two-layer or multilayer film composite;
a polymer film;
a polymer film having an aluminum layer;
an aluminum layer;
a paper web; and
a biologically degradable film.

10. The method according to claim 1, wherein diffractive optics are used in order to generate at least two holes simultaneously during perforation of the flexible material.

11. An apparatus for producing a packaging by means of microperforation of a flexible material as a packaging film and for carrying out the method according to claim 1, comprising a transport apparatus for transporting the flexible material, wherein the laser of the laser system has a wavelength in the range of from 150 nm to 1064 nm for perforating the flexible material, the laser system comprising one of the following:
i. an excimer laser,
ii. a UV laser,
iii. a nanosecond laser,
iv. a Q-switched DPSS solid-state laser; and
a positioning apparatus for positioning the laser beam on the flexible material during transport.

12. The apparatus according to claim 11, wherein the positioning apparatus comprises optics for positioning the laser beam, and the optics comprise at least one of:
a mobile mirror and a focusing device;
diffractive optics for generating at least two holes simultaneously during the perforation.

13. The apparatus according to claim 11, wherein the positioning apparatus is configured to guide the laser beam of the laser jointly with the flexible material during transport.

14. The apparatus according to claim 11, wherein the laser is configured to be operated in single-pulse operation or in the multiple-pulse method.

15. The apparatus according to claim 11, wherein the transport apparatus is configured for roll-to-roll transport of the flexible material, which is provided as a web.
